(19) United States
(12) Patent Application Publication
(10) Pub. No.: US 2012/0227699 A1
(43) Pub. Date: Sep. 13, 2012

(54) LINERLESS ENGINE

(75) Inventors: Thomas A. Perry, Bruce Township, MI (US); Michael J. Walker, Windsor (CA); Bob R. Powell, JR., Birmingham, MI (US); Anil K. Sachdev, Rochester Hills, MI (US); Herbert W. Doty, Amherst, NH (US); Michael J. Lukitsch, Marysville, MI (US)

(73) Assignee: GM GLOBAL TECHNOLOGY OPERATIONS LLC, Detroit, MI (US)

(21) Appl. No.: 13/042,854

(22) Filed: Mar. 8, 2011

(51) Int. Cl. F02F 3/00

(52) U.S. Cl. 123/193.4

(57) ABSTRACT

A linerless engine includes a casting defining a bore having an inner surface and a central longitudinal axis. The casting is formed from a castable aluminum-silicon alloy including silicon particles present a range of from about 11 to about 12.5 parts by weight. The inner surface has a surface variation defined by at least some of the silicon particles protruding toward the axis for from about 0.6 to about 1.5 microns. The linerless engine includes a piston slideably disposed within the bore and configured for translating along the axis, wherein the piston is formed from an aluminum alloy and includes a body having a skirt portion coated with a first coating, and at least one ring encircling and in contact with the body. The ring is coated with a diamond-like coating that is free from degradation when in contact with the at least some of the silicon particles.

### TECHNICAL FIELD

The present disclosure generally relates to an engine, and more specifically, to a linerless engine.

### BACKGROUND

Engines, such as internal combustion engines, generally include a metal cylinder block that defines one or more cylindrical bores, and a respective number of metal pistons that slideably translate within the bores during operation of the engine. Such engines are often operated at high temperatures and pressures, and the pistons may reversibly translate within the respective bores at a high speed. The pistons are generally fit to the bores at tight tolerances, and any deviation from tolerance may contribute to metal-to-metal contact between the piston and the bore. Such metal-to-metal contact may damage the bore and/or the piston. For example, the metal piston may scuff, scratch, and/or burnish the cylindrical bore. Damage from metal-to-metal contact may also be exacerbated when the piston and bore are formed from like materials, and/or when the engine is operated at extreme ambient temperatures.

To minimize such metal-to-metal contact between the piston and the comparatively softer metal of the cylinder block, liners or sleeves are often disposed between the piston and the respective bore by casting the cylinder block around the liners or sleeves. The liners or sleeves may be formed from a hard, durable material that does not degrade or become damaged upon contact with the metal of the piston. However, such liners may increase a weight of the engine, contribute to increased material and handling costs, and may complicate cylinder block casting and machining processes.

### SUMMARY

A linerless engine includes a casting defining a bore having an inner surface and a central longitudinal axis, wherein the casting is formed from a castable aluminum-silicon alloy. The castable aluminum-silicon alloy includes aluminum, and a plurality of silicon particles present in a range of from about 11 parts by weight to about 12.5 parts by weight based on 100 parts by weight of the castable aluminum-silicon alloy. The inner surface has a surface variation defined by at least some of the plurality of silicon particles protruding toward the central longitudinal axis for from about 0.6 microns to about 1.5 microns. The linerless engine also includes a piston slideably disposed within the bore. The piston is configured for translating along the central longitudinal axis and is formed from an aluminum alloy. Further, the piston includes a body having a skirt portion, wherein the skirt portion is coated with a first coating. The piston also includes at least one ring encircling the body in a plane perpendicular to the central longitudinal axis and disposed in contact with the body. The at least one ring is coated with a diamond-like coating that is substantially free from degradation when disposed in contact with the at least some of the plurality of silicon particles.

In one variation, the castable aluminum-silicon alloy also includes copper present in a range of greater than about 0.5 parts by weight based on 100 parts by weight of the castable aluminum-silicon alloy, nickel present in a range of greater than about 0.2 parts by weight based on 100 parts by weight of the castable aluminum-silicon alloy, magnesium present in a range of from about 0.2 parts by weight to about 1.0 part by weight based on 100 parts by weight of the castable aluminum-silicon alloy, and manganese and iron present in a ratio of greater than about 1.2 parts by weight of said magnesium to 1 part by weight of said iron based on 100 parts by weight of said castable aluminum-silicon alloy. Further, each of the plurality of inner surfaces defines a plurality of pores having an average size of less than about 100 microns and present in a range of less than about 0.1 parts by volume based on 100 parts by volume of the castable aluminum-silicon alloy. The linerless engine also includes a plurality of pistons each slideably disposed within a respective one of the plurality of bores to define a plurality of interspaces between each of the plurality of pistons and a respective one of the plurality of inner surfaces. Each of the plurality of interspaces has a first thickness of less than or equal to about 25 microns at a temperature of about −40° C. Further, each of the plurality of pistons is configured for reversibly translating along a respective one of the plurality of central longitudinal axes, is formed from an aluminum alloy, and has a cylindricity of less than about 15 microns. Each piston includes the body having the skirt portion, wherein the skirt portion is coated with the first coating, and at least one ring. The at least one ring encircles the body in a plane perpendicular to the respective central longitudinal axis and is disposed in contact with the body. The at least one ring has a first end and a second end spaced apart from the first end to define a gap therebetween having a second thickness of from about 4 microns to about 10 microns at a temperature of about −40° C. Further, the at least one ring is coated with a diamond-like coating that is substantially free from degradation when disposed in contact with the at least some of the plurality of silicon particles.

In another variation, each of the plurality of silicon particles has an average particle size of less than about 10 microns and an aspect ratio of less than about 3:1. The castable aluminum-silicon alloy is also substantially free from primary silicon. In addition, the body of the each of the plurality of pistons has a proximal edge, a distal edge spaced apart from the proximal edge, and a skirt portion disposed between the distal edge and the proximal edge. The skirt portion is coated with the first coating that is non-sacrificial and minimizes contact between the aluminum alloy of the piston and the aluminum of the casting as the piston reversibly translates along the respective central longitudinal axis. The at least one ring is also coated with the diamond-like coating that is non-sacrificial and substantially free from degradation when disposed in contact with the at least some of the plurality of silicon particles to thereby minimize contact between the at least one ring and the aluminum of the casting as the piston reversibly translates along the respective central longitudinal axis.

The linerless engine exhibits excellent wear- and scuff-resistance, especially when operated at low temperatures during “cold starts”. In particular, the castable aluminum-silicon alloy is hard and durable, and therefore minimizes sinking of the silicon particles into the aluminum phase of the castable aluminum-silicon alloy. Further, the first coating of the piston skirt portion and the diamond-like coating of the at least one ring both minimize potential damage, e.g., scuffs and burnish marks, to the linerless engine. That is, the linerless engine minimizes metal-to-metal contact between the inner surface of the bore and the piston as the piston translates within the bore during operation of the linerless engine. Further, the silicon particles protruding from the inner surface of the bore may not fracture during operation of the linerless engine, and therefore minimize debris that accelerates onset of abrasive wear within the bore. Further, the castable aluminum-silicon alloy is castable and machinable. More specifically, the castable aluminum-silicon alloy allows for adequate metal feeding during casting solidification and does not abrade cutting tools during machining In addition, the linerless engine minimizes oil consumption through controlled bore porosity and cylindricity of the piston, and minimizes damage to the bore from ring-butting at low temperatures. Also, since the linerless engine does not include liners, the linerless engine minimizes costs associated with weight, material handling operations, and casting and machining processes.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic perspective view of a linerless engine including a casting defining a bore for a piston slideably disposable within the bore, wherein the casting is formed from a castable aluminum-silicon alloy including a plurality of silicon particles;

FIG. 2 is a schematic exploded view of the piston of FIG. 1, wherein the piston includes a body and at least one ring for encircling the body;

FIG. 3 is a schematic side view of the assembled piston of FIGS. 1 and 2;

FIG. 4 is a schematic cross-sectional view of the piston of FIGS. 2 and 3 slideably disposed within the bore of FIG. 1;

FIG. 5 is a schematic magnified cross-sectional view of a portion of the piston and bore of FIG. 4;

FIG. 6 is a schematic cross-sectional view of the ring of FIG. 2 taken along line 6-6;

FIG. 7 is a schematic cross-sectional view of a portion of the piston of FIG. 2 taken along line 7-7; and

FIG. 8 is a schematic side view of one of the plurality of silicon particles of FIG. 1.

### DETAILED DESCRIPTION

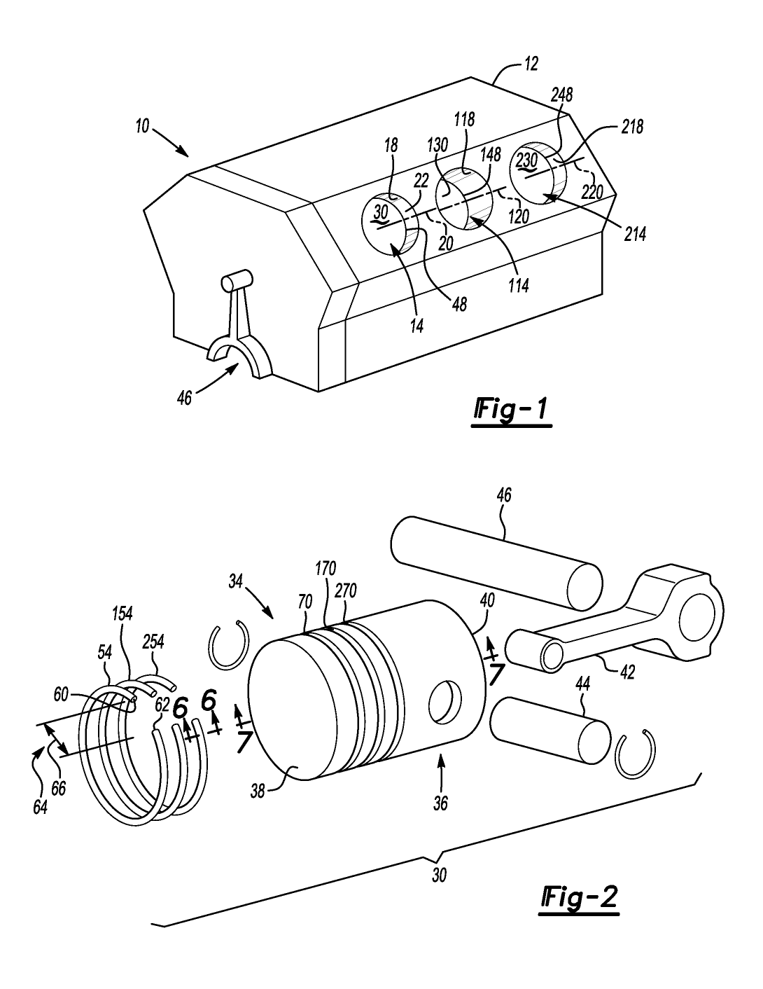

Referring to the Figures, wherein like reference numerals refer to like elements, a linerless engine is shown generally at 10 in FIG. 1. The linerless engine 10 may provide power to a device or system. As a non-limiting example, the linerless engine 10 may be a gasoline-fueled internal combustion engine. Therefore, the linerless engine 10 may be useful for automotive applications. However, based upon the excellent wear- and scuff-resistance of the linerless engine 10, especially when operated at low temperatures during “cold starts” as set forth in more detail below, the linerless engine 10 may also be useful for non-automotive applications, such as, but not limited to, aviation, rail, marine, stationary power generator, and recreational vehicle applications.

Referring to FIG. 1, the linerless engine 10 includes a casting 12 defining a bore 14. The casting 12 may be a cylinder block of the linerless engine 10 and may be cast and/or machined to define the bore 14. Further, the casting 12 may be formed from a castable aluminum-silicon alloy, as set forth in more detail below. As used herein, the terminology “linerless” refers to an engine that is substantially free from a liner or sleeve disposed in contact with the bore 14. That is, the linerless engine 10 does not require or include the liner or sleeve within the bore 14 for protection of the bore 14 during operation of the linerless engine 10.

Although dependent upon the desired application of the casting 12, the casting 12 may be formed by any suitable casting method that includes solidifying the castable aluminum-silicon alloy from a molten state to a solid state. For example, the casting method may include one or more of die casting, permanent mold casting, semi-permanent mold casting, bonded sand casting, lost foam casting, precision sand casting, and combinations thereof. In one variation, the casting 12 may be cast in a suitable mold (not shown) at a melt temperature of from about 630° C. to about 815° C., e.g., from about 630° C. to about 650° C. In addition, the suitable mold (not shown) may include metal chills to facilitate directional solidification of molten material and/or refine the microstructure of the formed casting 12.

Further, the casting method may include heat treatment to enhance mechanical properties of the casting 12 and/or precipitation hardening treatments. For example, the casting 12 may be formed after a T6 temper, wherein the T6 temper includes a solution treatment at a temperature near, but less than, a solidus temperature of the castable aluminum-silicon alloy, for from about 4 hours to about 12 hours, and an aging treatment of about 180° C. for from about 4 hours to about 8 hours.

After the casting 12 is formed, the casting 12 may also be washed, machined, and/or finished. For example, the casting 12 may be washed to minimize debris present in the bore 14 to prevent scuffing and/or wear of components of the linerless engine 10 during operation. Alternatively or additionally, the casting 12 may be machined at a maximum rough cutting depth of less than about 500 microns, i.e., 500×10⁻⁶ meters, to minimize damage to constituents of the castable aluminum-silicon alloy, and may be finished at a maximum cutting depth of less than about 125 microns to correct any subsurface damage to the casting 12 during formation.

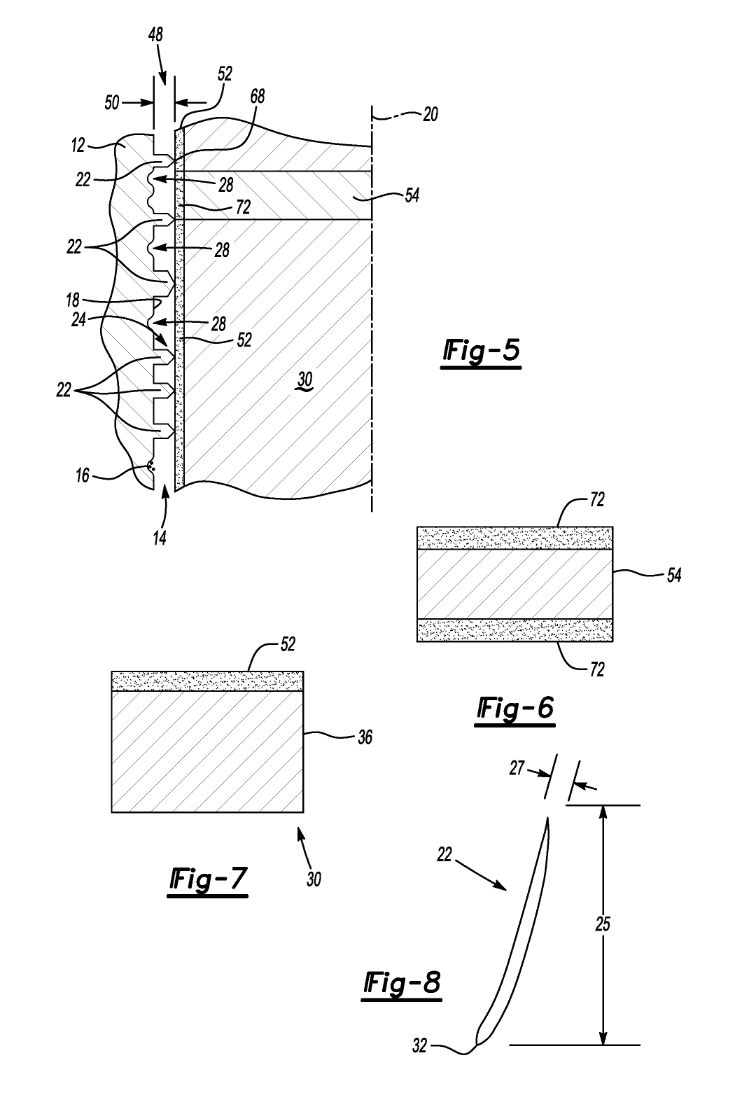

Referring again to FIG. 1, in one variation, the casting 12 may define a plurality of bores 14, 114, 214. By way of non-limiting examples, the casting 12 may define two, four, six, eight, or twelve bores 14, 114, 214 so that the linerless engine 10 may be configured as a 2-cylinder, 4-cylinder, 6-cylinder, 8-cylinder, or 12-cylinder linerless engine 10. Further, although the plurality of bores 14, 114, 214 is shown in a “V” configuration in FIG. 1, i.e., in a V-6 configuration, so that three bores 14, 114, 214 of one branch of the “V” are visible, the plurality of bores 14, 114, 214 may also be arranged in series to form an in-line linerless engine 10 or other multi-cylinder linerless engine, such as, but not limited to, a linerless engine 10 having a “W” configuration or a linerless engine 10 having an opposed “boxer” configuration. Further, as set forth above, the linerless engine 10 may be a single-cylinder linerless engine 10. Therefore, the linerless engine 10 may be suitable for any application requiring scuff- and wear-resistance of the bores 14, 114, 214, especially when the linerless engine 10 is operated at low temperatures during “cold starts” and/or high temperatures during full power output. As used herein, the terminology “cold start” refers to an operating condition of the linerless engine 10 including low temperatures, e.g., less than about −30° C., and high loads or high speeds, e.g., greater than about 5,000 revolutions per minute (rpm). During such operating conditions, the linerless engine 10 may experience reduced lubrication from an oil (shown generally at 16 in FIG. 5).

Referring now to FIGS. 1 and 4, the bore 14 may have an inner surface 18 and a central longitudinal axis 20. The central longitudinal axis 20 may extend along a length of the bore 14, and the inner surface 18 may be opposed and spaced apart from the central longitudinal axis 20. In the variation including the plurality of bores 14, 114, 214, each bore 14, 114, 214 has a respective inner surface 18, 118, 218 and a respective central longitudinal axis 20, 120, 220 as shown in FIG. 1.

Referring again to FIG. 1, the casting 12 of the linerless engine 10 is formed from a castable aluminum-silicon alloy including aluminum, and a plurality of silicon particles 22 (shown in greater detail in FIGS. 5 and 8). The aluminum may be present in the castable aluminum-silicon alloy in a comparatively larger amount than any other component of the castable aluminum-silicon alloy and may provide structure and hardness to the castable aluminum-silicon alloy.

The plurality of silicon particles 22 may be present in the castable aluminum-silicon alloy to provide the castable aluminum-silicon alloy with increased scuff- and wear-resistance, as set forth in more detail below. More specifically, the plurality of silicon particles 22 is present in a range of from about 11 parts by weight to about 12.5 parts by weight based on 100 parts by weight of the castable aluminum-silicon alloy. For example, the plurality of silicon particles 22 may be present in a range of from about 11.8 parts by weight to about 12.5 parts by weight based on 100 parts by weight of the castable aluminum-silicon alloy. That is, the castable aluminum-silicon alloy may be a eutectic or near-eutectic alloy. At amounts less than about 11 parts by weight of the plurality of silicon particles 22, the castable aluminum-silicon alloy and formed casting 12 may not exhibit adequate scuff- and wear-resistance during operation at low temperatures, e.g., at less than −30° C., as set forth in more detail below. In contrast, at amounts greater than about 12.5 parts by weight of the plurality of silicon particles 22, the castable aluminum-silicon alloy may be difficult to process, i.e., cast and/or machine, due to an increased requirement for heat dissipation during solidification and machining tool wear upon exposure to any primary silicon particles. Further, it is to be appreciated that at the eutectic temperature, up to about 1.5 parts by weight of the plurality of silicon particles 22 may be dissolved in the aforementioned aluminum, and therefore may not be present in particle form. That is, the castable aluminum-silicon alloy may include, for example, from about 9.5 parts by weight to about 12.5 parts by weight total silicon (in any form) based on 100 parts by weight of the castable aluminum-silicon alloy.

The plurality of silicon particles 22 may include fine, modified silicon. Further, the plurality of silicon particles 22 may have an average particle size of less than about 10 microns, e.g., from about 5 microns to about 8 microns. Further, each of the plurality of silicon particles 22 may have an acicular shape (shown generally in FIG. 8), i.e., needle-like shape, and may have an aspect ratio, i.e., a ratio of a longest dimension 25 to shortest dimension 27, of less than about 3:1. Silicon particles 22 having larger aspect ratios may also decrease the scuff- and wear-resistance of the casting 12 formed from the castable aluminum-silicon alloy. For example, silicon particles 22 having an average particle size of greater than about 10 microns and/or an aspect ratio of greater than about 3:1 may abrasively damage a counterface or cutting tool of the casting 12 formed from the castable aluminum-silicon alloy.

In addition, the castable aluminum-silicon alloy may be substantially free from primary silicon. Generally, primary silicon is coarse and may be avoided in the castable aluminum-silicon alloy to thereby optimize metal feeding during casting solidification and/or minimize abrasive wear of cutting tools during machining of the casting 12. Since primary silicon may be avoided in the castable aluminum-silicon alloy, remaining silicon may be in a eutectic structure with the aluminum.

Referring now to FIG. 5, the inner surface 18 has a surface variation 24 defined by at least some of the plurality of silicon particles 22 protruding toward the central longitudinal axis 20 for from about 0.6 microns to about 1.5 microns. Although FIG. 5 depicts representative piston 30 slideably disposed within representative bore 14, it is to be appreciated that like reference numerals refer to like components of pistons 130, 230 and bores 114, 214. As shown greatly magnified in FIG. 5, an end 32 (FIG. 8) or other portion of the at least some of the plurality of silicon particles 22 of the surface variation 24 may protrude or extend from the inner surface 18 toward the central longitudinal axis 20 of the bore 14 for from about 0.6 microns to about 1.5 microns, e.g., from about 0.8 microns to about 1.3 microns. That is, a first portion of the plurality of silicon particles 22 of the castable aluminum-silicon alloy may “lie flat”, i.e., may be positioned within the castable aluminum-silicon alloy so that the longest dimension 25 of the silicon particle 22 is substantially parallel to the central longitudinal axis 20 of the bore 14, and generally define the inner surface 18. Another portion, i.e., the at least some of the plurality of silicon particles 22, may protrude toward the central longitudinal axis 20 so that the inner surface 18 has the surface variation 24. At protrusion distances of less than about 0.6 microns, the inner surface 18 of the bore 14 may not exhibit adequate wear- and scuff-resistance. Likewise, at protrusion distances of greater than about 1.5 microns, the at least some of the plurality of silicon particles 22 of the surface variation 24 may fracture and/or shear off the inner surface 18, which may in turn deposit debris within the bore 14 and contribute to abrasive wear of the bore 14. As shown in FIG. 5, the at least some of the plurality of silicon particles 22 of the surface variation 24 that protrude toward the central longitudinal axis 20 provide a sliding surface for another component of the linerless engine 10, as set forth in more detail below. In addition, the at least some of the plurality of silicon particles 22 of the surface variation 24 may be load-bearing during operation of the linerless engine 10, as also set forth in more detail below.

The inner surface 18 of the bore 14 may be chemically etched. For example, the inner surface 18 may be chemically etched in a 10% NaOH solution for about 3 minutes to provide the at least some of the plurality of silicon particles 22 that protrude from the inner surface 18, as set forth above. That is, the inner surface 18 of each bore 14 may be chemically etched so that the at least some of the plurality of silicon particles 22 of the surface variation 24 protrude toward the central longitudinal axis 20 for from about 0.6 microns to about 1.5 microns. The inner surface 18 may be chemically etched to also minimize any smeared aluminum on the inner surface 18 of the bore 14 after casting and/or machining

Alternatively or additionally, the inner surface 18 of the bore 14 may be mechanically roughened to provide the at least some of the plurality of silicon particles 22 that protrude from the inner surface 18, as set forth above. That is, the inner surface 18 of each bore 14 may be mechanically roughened so that the at least some of the plurality of silicon particles 22 of the surface variation 24 protrude toward the central longitudinal axis 20 for from about 0.6 microns to about 1.5 microns. The inner surface 18 may be mechanically roughened to also minimize any smeared aluminum on the inner surface 18 of the bore 14 after casting and/or machining

In addition, the castable aluminum-silicon alloy may further include copper present in a range of greater than about 0.5 parts by weight based on 100 parts by weight of the castable aluminum-silicon alloy. The copper may provide the castable aluminum-silicon alloy with adequate strength, hardness, and castablility. More specifically, without intending to be limited by theory, intermetallics, i.e., solid phases including two or more metallic elements, may form during solidification of the castable aluminum-silicon alloy, and/or fine precipitates may form following heat treatment, e.g., solution hardening and aging, of the castable aluminum-silicon alloy. Such intermetallics and/or fine precipitates may provide the castable aluminum-silicon alloy with the aforementioned strength, hardness, and castability. Therefore, at copper amounts of less than about 0.5 parts by weight, the castable aluminum-silicon alloy may not exhibit adequate strength following casting and solidification, and the inner surface 18 of the bore 14 may not exhibit adequate hardness, i.e., a hardness of greater than or equal to 105 HB 10/500/30, for operation of the linerless engine 10.

The castable aluminum-silicon alloy may also further include nickel present in a range of greater than about 0.2 parts by weight based on 100 parts by weight of the castable aluminum-silicon alloy. The nickel may provide the castable aluminum-silicon alloy with adequate strength and hardness due to intermetallic formation during solidification. At nickel amounts of less than about 0.2 parts by weight, the castable aluminum-silicon alloy may not exhibit adequate strength following casting and solidification, and the inner surface 18 of the bore 14 may not exhibit adequate hardness, i.e., a hardness of greater than or equal to 105 HB 10/500/30, for operation of the linerless engine 10.

In addition, the castable aluminum-silicon alloy may further include magnesium present in a range of from about 0.2 parts by weight to about 1.0 part by weight based on 100 parts by weight of the castable aluminum-silicon alloy. Magnesium present at the aforementioned range may provide the castable aluminum-silicon alloy with adequate hardness after casting. More specifically, the inner surface 18 (FIG. 4) of the bore 14 defined by the casting 12 formed from the castable aluminum-silicon alloy may have a hardness of greater than or equal to 105 HB 10/500/30 when measured in accordance with the Brinell Hardness Test. That is, 10/500/30 nomenclature denotes that the inner surface 18 may have a Brinell hardness of at least 105 HB using a 10 mm-diameter hardened steel ball with a 500 kilogram load applied for a period of 30 seconds. Such hardness may also minimize sinking of the plurality of silicon particles 22 into the aluminum of the castable aluminum-silicon alloy from any loads acting on the protruding plurality of silicon particles 22.

Additionally, the castable aluminum-silicon alloy may further include manganese and iron present in a ratio of greater than about 1.2 parts by weight of the manganese to 1 part by weight of the iron based on 100 parts by weight of the castable aluminum-silicon alloy. That is, the castable aluminum-silicon alloy may include comparatively more manganese than iron. The manganese and iron may be present in the aforementioned ratio to minimize porosity of the inner surface 18 (FIG. 4).

That is, as best shown in FIG. 5, the inner surface 18 of each bore 14 may define a plurality of pores 28 present in a range of less than about 0.1 parts by volume based on 100 parts by volume of the castable aluminum-silicon alloy. Stated differently, the inner surface 18 may have a porosity of less than or equal to 0.1%. Further, the plurality of pores 28 may have an average size of less than about 100 microns. Such minimized porosity may contribute to the efficiency of the linerless engine 10, as set forth in more detail below. For example, the aforementioned porosity may minimize consumption of oil 16 and reduce emissions during operation of the linerless engine 10. That is, the aforementioned porosity may minimize an amount of oil 16 that may reside in, and subsequently burn off from, the plurality of pores 22 during combustion or operation of the linerless engine 10.

The castable aluminum-silicon alloy may also include trace amounts of other alloying elements, such as, but not limited to, titanium, boron, sodium, strontium, and zirconium to control grain size and the shape of the plurality of silicon particles 22.

Referring now to FIGS. 1-4, the linerless engine 10 also includes a piston 30 slideably disposed within the bore 14 and configured for translating along the central longitudinal axis 20 (FIG. 4). That is, during operation of the linerless engine 10, the piston 30 may reversibly translate within the bore 14 along the central longitudinal axis 20 in a direction indicated by arrows 33 (FIG. 4). The piston 30 may be suitably sized and shaped according to the diameter of the bore 14 and the desired power output of the linerless engine 10. In particular, the piston 30 may be shaped to withstand a compression of a fuel-air mixture within the bore 14. Such compression may drive the reversible translation of the piston 30 along the central longitudinal axis 20 within the bore 14. Further, the piston 30 is formed from an aluminum alloy. The aluminum alloy of the piston 30 may also be selected according to operating conditions of the linerless engine 10, such as temperature and pressure.

In one variation, as shown in FIG. 1, the linerless engine 10 may include a plurality of pistons 30, 130, 230. Generally, the linerless engine 10 may include an equal number of pistons 30, 130, 230 and bores 14, 114, 214. That is, the plurality of pistons 30, 130, 230 may each be slideably disposed within a respective one of the plurality of bores 14, 114, 214, and each of the plurality of pistons 30, 130, 230 may be configured for reversibly translating along the respective central longitudinal axis 20, 120, 220. In this variation, each piston 30, 130, 230 is also formed from the aluminum alloy.

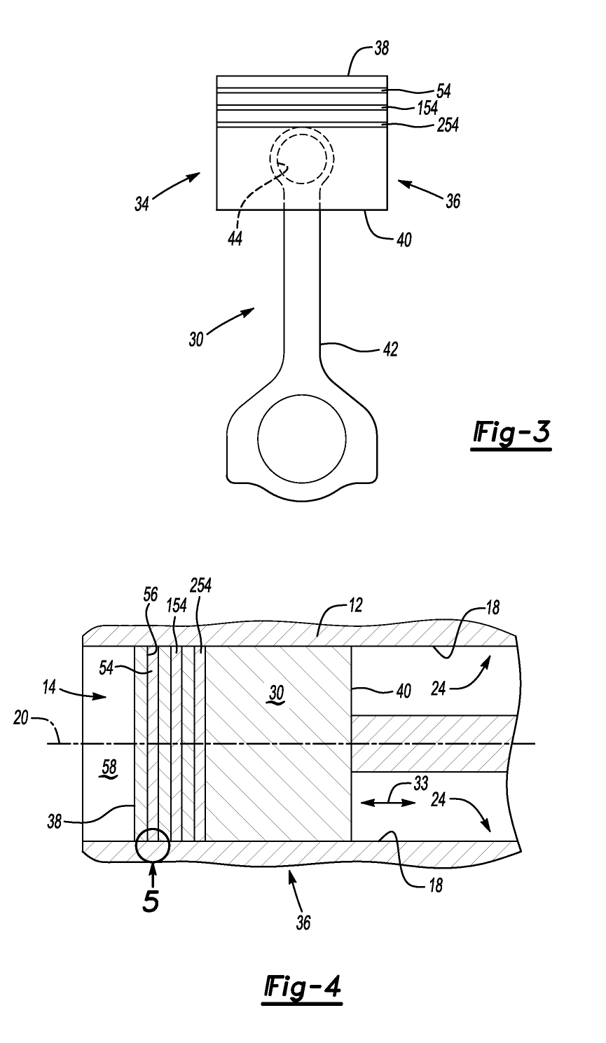

As shown in FIGS. 2 and 3, the piston 30 includes a body 34 having a skirt portion 36. In particular, the body 34 may have a proximal edge 38, a distal edge 40 spaced apart from the proximal edge 38, and the skirt portion 36 disposed between the distal edge 40 and the proximal edge 38. The body 34 may be connected to a connecting rod 42 by a wrist pin 44 and may be sized to slideably translate within the bore 14 as set forth above. Further, the connecting rod 42 of the piston 30 may be operatively connected to a crankshaft (shown generally at 46 in FIGS. 1 and 2) of the linerless engine 10. Therefore, as the piston 30 slideably translates within the bore 14 during operation of the linerless engine 10, the linerless engine 10 may convert linear motion of the piston 30 to rotational motion of the crankshaft 46, and thereby provide motive power for a vehicle (not shown) or system.

Referring now to FIGS. 3, 4, and 7, the skirt portion 36 may have a cylindrical shape and may be formed from the aluminum alloy. In particular, the piston 30 may have a cylindricity of less than about 15 microns. As used herein, the terminology “cylindricity” refers to a tolerance value between two reference cylinders, e.g., the skirt portion 36 of the piston 30 and the bore 14 of the casting 12. A cylindricity of less than about 15 microns provides excellent circularity and straightness of the piston 30, and minimizes taper of the body 34 from the proximal edge 38 to the distal edge 40. The aforementioned cylindricity also minimizes metal-to-metal contact between the piston 30 and the inner surface 18 of the bore 14 as the piston 30 reversibly translates along the central longitudinal axis 20 during operation of the linerless engine 10, as set forth in more detail below. That is, referring to FIG. 1, the piston 30 may have an excellent fit or guidance within the bore 14 so as to minimize damage to the inner surface 18 of the bore 14 in the form of burnish marks during operation of the linerless engine 10. In particular, referring to FIG. 5, the piston 30 and the bore 14 may define an interspace 48 therebetween having a first thickness 50 of less than or equal to about 25 microns at a temperature of about −40 ° C. For example, the piston 30 may have an interference fit within the bore 14.

Referring now to FIG. 7, the skirt portion 36 is coated with a first coating 52. The first coating 52 may be non-sacrificial. That is, the first coating 52 may not degrade, smear, and/or transfer to an opposing surface, e.g., the inner surface 18 (FIG. 5) of the bore 14 (FIG. 5), during operation of the linerless engine 10 (FIG. 1). Non-limiting examples of suitable first coatings include nickel-composite coatings, iron coatings, and any other non-sacrificial coating that does not damage the inner surface 18 or negate the aforementioned benefits of the protruding plurality of silicon particles 22. In particular, the first coating 52 may be an electroless nickel coating reinforced with, e.g., diamond, silicon carbide, silicon nitride, hexagonal boron nitride, polytetrafluoroethylene, and combinations thereof. Generally, the first coating 52 disposed on the skirt portion 36 may have a surface roughness, R_{z}, of less than about 10 microns. A surface roughness, R_{z}, of greater than about 10 microns may contribute to burnish marks and scuffing during operation of the linerless engine 10, which may alter the microstructure of the inner surface 18 of the bore 14. Such altered microstructure may in turn contribute to decreased durability of the linerless engine 10.

As described with reference to FIGS. 5 and 7, the first coating 52 may be disposed on the skirt portion 36 and may minimize contact between the aluminum alloy of the piston 30 and the aluminum of the casting 12 as the piston 30 translates, e.g., reversibly translates, along the central longitudinal axis 20. That is, the first coating 52 may minimize scuffing of the inner surface 18 of the bore 14 and contribute to the excellent scuff-resistance of the linerless engine 10. The first coating 52 specifically minimizes scuffing during operation of the linerless engine 10 at low temperatures, e.g., less than about −30° C., during “cold starts”. Since such operating conditions may include low lubrication within the linerless engine 10, i.e., relatively low levels of oil 16 (FIG. 5) as compared to standard operation, the first coating 52 may minimize aluminum-to-aluminum contact between the piston 30 and the inner surface 18 of the bore 14 defined by the casting 12 formed from the castable aluminum-silicon alloy.

Referring again to FIGS. 2-4, the piston 30 also includes at least one ring 54 encircling the body 34 in a plane 56 perpendicular to the central longitudinal axis 20 (FIG. 4) and disposed in contact with the body 34. That is, the at least one ring 54 may wrap around the body 34 of the piston 30 and may be disposed in contact with the body 34 between the skirt portion 36 and the proximal edge 38 of the piston 30. The at least one ring 54 may be configured to seal a combustion chamber 58 (FIG. 4) within the bore 14 and regulate consumption of oil 16 (FIG. 5) within the bore 14.

As shown in FIG. 2, the at least one ring 54 may have a first end 60 and a second end 62 spaced apart from the first end 60 to define a gap 64 therebetween. That is, the at least one ring 54 may be an open-ended ring that is configured for compressing around the body 34. The gap 64 may have a second thickness 66 of from about 4 microns to about 10 microns at a temperature of about −40° C. Such minimal gaps 64 ensure an excellent combustion seal 68 (FIG. 5) and provide adequate clearance or distance between the first end 60 and the second end 62 so that the ends 60, 62 do not overlap or abut one another, and/or scuff the inner surface 18 during operation of the linerless engine 10 during “cold starts”. That is, since the first end 60 and the second end 62 of the at least one ring 54 may be subjected to high pressures at low temperatures, e.g., operating temperatures of less than about −30° C., the aforementioned second thickness 66 of the gap 64 between the first end 60 and the second end 62 allows for thermal expansion and contraction of the at least one ring 54 and bore 14, even when such thermal expansion and contraction may occur at different rates.

As further shown in FIG. 2, the body 34 of the piston 30 may define at least one groove 70, 170, 270 or seat for the at least one ring 54. Therefore, when the at least one ring 54 encircles and contacts the body 34, the at least one ring 54 may extend from the surface of the body 34 slightly. That is, although the piston 30 may have a substantially uniform diameter from the proximal edge 38 to the distal edge 40, the at least one ring 54 may be configured to abut at least some of the plurality of silicon particles 22 (FIG. 5) within the bore 14 to thereby form the seal 68 between the piston 30 and the bore 14, as set forth in more detail below. The at least one ring 54 may be formed from any suitable material, e.g., steel or cast iron.

With continued reference to FIGS. 2 and 3, the piston 30 may include a plurality of rings 54, 154, 254. In this variation, the two rings 54, 154 situated nearest the proximal edge 38 of the body 34 may be configured as compression rings, and the ring 254 situated nearest the distal edge 40 of the body 34 may be configured as an oil control ring. However, the configuration of the plurality of rings 54, 154, 254 illustrated in FIGS. 2-4 is non-limiting, and the piston 30 may include any number or configuration of rings 54.

Referring now to FIGS. 5 and 6, the at least one ring 54 is coated with a diamond-like coating 72 that is substantially free from degradation when disposed in contact with the at least some of the plurality of silicon particles 22. The diamond-like coating 72 is also non-sacrificial. That is, the diamond-like coating 72 may not degrade, smear, and/or transfer to an opposing surface, e.g., the inner surface 18 of the bore 14, as the piston 30 translates within the bore 14 along the central longitudinal axis 20. Non-limiting suitable examples of diamond-like coatings 72 generally include amorphous carbon and exhibit excellent hardness. A specific suitable example of the diamond-like coating 72 may include TriboBond 40 commercially available from Ionbond US of Madison Heights, Mich.

Generally, the diamond-like coating 72 disposed on the at least one ring 54 may have a hardness of greater than or equal to about 1,000 VHN, i.e., 10 GPa, when measured in accordance with the Vickers Hardness Test. A hardness of less than about 1,000 VHN may contribute to degradation of the diamond-like coating 72 during operation of the linerless engine 10 from contact of the diamond-like coating 72 with the at least some of the plurality of silicon particles 22 (FIG. 5), which may wear away the diamond-like coating 72 and expose the uncoated ring 54 to the inner surface 18 of the bore 14. Such contact and degradation may in turn contribute to decreased durability of the linerless engine 10.

As described with reference to FIG. 5, the diamond-like coating 72 may contact the at least some of the plurality of silicon particles 22 as the piston 30 translates along the central longitudinal axis 20 to thereby form a seal 68 between the at least one ring 54 and the inner surface 18 of the bore 14. More specifically, the at least one ring 54 coated with the diamond-like coating 72 may form the seal 68 between the at least one ring 54 and the at least some of the plurality of silicon particles 22 of the surface variation 24 that protrude or extend toward the central longitudinal axis 20.

Therefore, as described with reference to FIG. 5, the diamond-like coating 72 may be disposed on the at least one ring 54, and may be non-sacrificial and substantially free from degradation when disposed in contact with the at least some of the plurality of silicon particles 22 to thereby minimize contact between the at least one ring 54 and the aluminum of the casting 12 as the piston 30 translates, e.g., reversibly translates, along the respective central longitudinal axis 20. That is, the diamond-like coating 72 may minimize scuffing of the inner surface 18 of the bore 14 and contribute to the excellent scuff-resistance of the linerless engine 10. The diamond-like coating 72 may specifically minimize scuffing during operation of the linerless engine 10 at low temperatures, e.g., less than about −30° C., during “cold starts”. Since such operating conditions may include low lubrication within the linerless engine 10, i.e., relatively low levels of oil 16 (FIG. 5) as compared to standard operation, the diamond-like coating 72 may minimize metal-to-metal contact between the at least one ring 54 and the inner surface 18 of the bore 14 defined by the casting 12 formed from the castable aluminum-silicon alloy.

Based on the aforementioned compositions of the bore 14 and piston 30, the bore 14 and piston 30 each expand and contract at a substantially similar rate during operation of the linerless engine 10, even during “cold starts” and high engine loads. Therefore, the linerless engine 10 exhibits excellent durability and scuff-resistance.

Referring again to FIG. 5, the linerless engine 10 may further include the oil 16 disposed in contact with each of the plurality of bores 14 and plurality of pistons 30. During operation of the linerless engine 10, the oil 16 may be deposited within the plurality of pores 28 at a rate of less than or equal to about 10 grams of oil 16 per hour as the plurality of pistons 30 each reversibly translates along the respective central longitudinal axis 20.

In one non-limiting variation, as described with reference to the Figures, the linerless engine 10 includes the casting 12 defining the plurality of bores 14, 114, 214 each having the inner surface 18, 118, 218 and the central longitudinal axis 20, 120, 220. The casting 12 is formed from the castable aluminum-silicon alloy including aluminum and the plurality of silicon particles 22 present in a range of from about 11 parts by weight to about 12.5 parts by weight based on 100 parts by weight of the castable aluminum-silicon alloy. The inner surface 18, 118, 218 has the surface variation 24 defined by the at least some of the plurality of silicon particles 22 protruding toward each of the respective central longitudinal axis 20, 120, 220 for from about 0.6 microns to about 1.5 microns. The castable aluminum-silicon alloy also includes copper present in a range of greater than about 0.5 parts by weight based on 100 parts by weight of the castable aluminum-silicon alloy, nickel present in a range of greater than about 0.2 parts by weight based on 100 parts by weight of the castable aluminum-silicon alloy, magnesium present in a range of from about 0.2 parts by weight to about 1.0 part by weight based on 100 parts by weight of the castable aluminum-silicon alloy, and manganese and iron present in a ratio of greater than about 1.2 parts by weight of the manganese to 1 part by weight of the iron based on 100 parts by weight of the castable aluminum-silicon alloy. Each of the plurality of inner surfaces 18, 118, 218 defines the plurality of pores 28 having an average size of less than about 100 microns and present in a range of less than about 0.1 parts by volume based on 100 parts by volume of the castable aluminum-silicon alloy.

In this variation, the linerless engine 10 also includes the plurality of pistons 30, 130, 230 each slideably disposed within a respective one of the plurality of bores 14, 114, 214 to define a plurality of interspaces 48, 148, 248 between each of the plurality of pistons 30, 130, 230 and the respective one of the plurality of inner surfaces 18, 118, 218. Each of the plurality of interspaces 48, 148, 248 has the first thickness 50 of less than or equal to about 25 microns at a temperature of about −40° C. Further, each of the plurality of pistons 30, 130, 230 is configured for reversibly translating along a respective one of the plurality of central longitudinal axes 20, 120, 220, is formed from an aluminum alloy, and has a cylindricity of less than about 15 microns.

For this variation, each of the plurality of pistons 30, 130, 230 includes the body 34 having the skirt portion 36, wherein the skirt portion 36 is coated with the first coating 52, and at least one ring 54 encircling the body 34 in a plane 56 perpendicular to the respective central longitudinal axis 20, 120, 220 and disposed in contact with the body 34. The at least one ring 54 has the first end 60 and the second end 62 spaced apart from the first end 60 to define the gap 64 therebetween having the second thickness 66 of from about 4 microns to about 10 microns at a temperature of about −40° C. The at least one ring 54 is coated with the diamond-like coating 72 that is substantially free from degradation when disposed in contact with the at least some of the plurality of silicon particles 22.

In another non-limiting variation, as described with reference to the Figures, the linerless engine 10 includes the casting 12 defining the plurality of bores 14, 114, 214 each having the inner surface 18, 118, 218 and the central longitudinal axis 20, 120, 220, wherein the casting 12 is formed from the castable aluminum-silicon alloy. The castable aluminum-silicon alloy includes aluminum and the plurality of silicon particles 22 present in a range of from about 11 parts by weight to about 12.5 parts by weight of the castable aluminum-silicon alloy. Each of the plurality of silicon particles 22 has an average particle size of less than about 10 microns and an aspect ratio of less than about 3:1. The inner surface 18, 118, 218 has the surface variation 24 defined by at least some of the plurality of silicon particles 22 protruding toward each of the respective central longitudinal axes 20, 120, 220 for from about 0.6 microns to about 1.5 microns.

In this variation, the castable aluminum-silicon alloy also includes copper present in a range of greater than about 0.5 parts by weight based on 100 parts by weight of the castable aluminum-silicon alloy, nickel present in a range of greater than about 0.2 parts by weight based on 100 parts by weight of the castable aluminum-silicon alloy, magnesium present in a range of about 0.2 parts by weight to about 1.0 part by weight based on 100 parts by weight of the castable aluminum-silicon alloy, and manganese and iron present in a ratio of greater than about 1.2 parts by weight of the manganese to 1 part by weight of the iron based on 100 parts by weight of the castable aluminum-silicon alloy. In addition, the castable aluminum-silicon alloy is substantially free from primary silicon.

For this variation, each of the plurality of inner surfaces 18, 118, 218 defines the plurality of pores 28 having an average particle size of less than about 100 microns and present in a range of less than about 0.1 parts by volume based on 100 parts by volume of the castable aluminum-silicon alloy.

Further, the linerless engine 10 includes the plurality of pistons 30, 130, 230 each slideably disposed within the respective one of the plurality of bores 14, 114, 214 to define the plurality of interspaces 48, 148, 248 between each of the plurality of pistons 30, 130, 230 and the respective one of the plurality of inner surfaces 18, 118, 218, wherein each of the plurality of interspaces 48, 148, 248 has the first thickness 50 of less than or equal to about 25 microns at a temperature of about −40° C. Each of the plurality of pistons 30, 130, 230 is configured for reversibly translating along a respective one of the plurality of central longitudinal axes 20, 120, 220 and is formed from an aluminum alloy.

Each of the plurality of pistons 30, 130, 230 includes a body 34 having the proximal edge 38, the distal edge 40 spaced apart from the proximal edge 38, and the skirt portion 36 disposed between the distal edge 40 and the proximal edge 38. The skirt portion 36 is coated with the first coating 52 at the distal edge 40 that is non-sacrificial and minimizes contact between the aluminum alloy of the piston 30, 130, 230 and the aluminum of the casting 12 as the piston 30, 130, 230 reversibly translates along the respective central longitudinal axis 20, 120, 220. The first coating 52 disposed on the skirt portion 36 has a surface roughness of less than about 10 microns.

For this variation, each of the plurality of pistons 30, 130, 230 also includes at least one ring 54 encircling the body 34 in a plane 56 perpendicular to the respective central longitudinal axis 20, 120, 220 and disposed in contact with the body 34 between the skirt portion 36 and the proximal edge 38. The at least one ring 54 has the first end 60 and the second end 62 spaced apart from the first end 60 to define the gap 64 therebetween. The gap 64 has the second thickness 66 of from about 4 microns to about 10 microns at a temperature of about −40° C. In addition, the at least one ring 54 is coated with the diamond-like coating 72 that is non-sacrificial and substantially free from degradation when disposed in contact with the at least some of the plurality of silicon particles 22 to thereby minimize contact between the at least one ring 54 and the aluminum of the casting 12 as the piston 30, 130, 230 reversibly translates along the respective central longitudinal axis 20, 120, 220.

The linerless engine 10 exhibits excellent wear- and scuff-resistance, especially when operated at low temperatures during “cold starts”. In particular, the castable aluminum-silicon alloy is hard and durable, and therefore minimizes sinking of the silicon particles 22 into the aluminum phase of the castable aluminum-silicon alloy. Further, the first coating 52 of the skirt portion 36 and the diamond-like coating 72 of the at least one ring 54 both minimize potential damage, e.g., scuffs and burnish marks, to the linerless engine 10. That is, the linerless engine 10 minimizes metal-to-metal contact between the inner surface 18 of the bore 14 and the piston 30 as the piston 30 translates within the bore 14 during operation of the linerless engine 10. Further, the plurality of silicon particles 22 protruding from the inner surface 18 of the bore 14 may not fracture during operation of the linerless engine 10, and therefore minimizes debris that accelerates onset of abrasive wear within the bore 14. Further, the castable aluminum-silicon alloy is castable and machinable. More specifically, the castable aluminum-silicon alloy allows for adequate metal feeding during casting solidification and does not abrade cutting tools during machining In addition, the linerless engine 10 minimizes consumption of oil 16 through controlled bore porosity and cylindricity of the piston 30, and minimizes damage to the bore 14 from ring-butting at low temperatures. Also, since the linerless engine 10 does not include liners, the linerless engine 10 minimizes costs associated with weight, material handling operations, and casting and machining processes.

While the best modes for carrying out the disclosure have been described in detail, those familiar with the art to which the disclosure relates will recognize various alternative designs and embodiments for practicing the disclosure within the scope of the appended claims.

1. A linerless engine comprising:
a casting defining a bore having an inner surface and a central longitudinal axis, wherein said casting is formed from a castable aluminum-silicon alloy including;
aluminum; and
a plurality of silicon particles present in a range of from about 11 parts by weight to about 12.5 parts by weight based on 100 parts by weight of said castable aluminum-silicon alloy;
wherein said inner surface has a surface variation defined by at least some of said plurality of silicon particles protruding toward said central longitudinal axis for from about 0.6 microns to about 1.5 microns; and
a piston slideably disposed within said bore and configured for translating along said central longitudinal axis, wherein said piston is formed from an aluminum alloy and includes;
a body having a skirt portion, wherein said skirt portion is coated with a first coating; and
at least one ring encircling said body in a plane perpendicular to said central longitudinal axis and disposed in contact with said body, wherein said at least one ring is coated with a diamond-like coating that is substantially free from degradation when disposed in contact with said at least some of said plurality of silicon particles.

2. The linerless engine of claim 1, wherein said first coating minimizes contact between said aluminum alloy of said piston and said aluminum of said casting as said piston translates along said central longitudinal axis.

3. The linerless engine of claim 1, wherein said castable aluminum-silicon alloy further includes manganese and iron present in a ratio of greater than about 1.2 parts by weight of said manganese to 1 part by weight of said iron based on 100 parts by weight of said castable aluminum-silicon alloy.

4. The linerless engine of claim 1, wherein said castable aluminum-silicon alloy further includes copper present in a range of greater than about 0.5 parts by weight based on 100 parts by weight of said castable aluminum-silicon alloy, nickel present in a range of greater than about 0.2 parts by weight based on 100 parts by weight of said castable aluminum-silicon alloy, and magnesium present in a range of from about 0.2 parts by weight to about 1.0 part by weight based on 100 parts by weight of said castable aluminum-silicon alloy.

5. The linerless engine of claim 1, wherein said plurality of silicon particles has an average particle size of less than about 10 microns.

6. The linerless engine of claim 5, wherein each of said plurality of silicon particles has an acicular shape and an aspect ratio of less than about 3:1.

7. The linerless engine of claim 1, wherein said castable aluminum-silicon alloy is substantially free from primary silicon.

8. The linerless engine of claim 1, wherein said piston and said bore define an interspace therebetween having a first thickness of less than or equal to about 25 microns at a temperature of about −40° C.

9. The linerless engine of claim 1, wherein said at least one ring has a first end and a second end spaced apart from said first end to define a gap therebetween having a second thickness of from about 4 microns to about 10 microns at a temperature of about −40° C.

10. The linerless engine of claim 1, wherein said inner surface defines a plurality of pores present in a range of less than about 0.1 parts by volume based on 100 parts by volume of said castable aluminum-silicon alloy.

11. The linerless engine of claim 10, wherein said plurality of pores has an average size of less than about 100 microns.

12. The linerless engine of claim 1, wherein said inner surface is chemically etched.

13. The linerless engine of claim 12, wherein said first coating disposed on said skirt portion has a surface roughness of less than about 10 microns.

14. The linerless engine of claim 1, wherein said diamond-like coating contacts said at least some of said plurality of silicon particles as said piston translates along said central longitudinal axis to thereby form a seal between said at least one ring and said inner surface of said bore.

15. The linerless engine of claim 14, wherein said diamond-like coating has a hardness of greater than or equal to about 1,000 VHN when measured in accordance with the Vickers Hardness Test.

16. The linerless engine of claim 1, wherein said inner surface has a hardness of greater than or equal to 105 HB 10/500/30 when measured in accordance with the Brinell Hardness Test.

17. The linerless engine of claim 1, wherein said piston has a cylindricity of less than about 15 microns.

18. A linerless engine comprising:
a casting defining a plurality of bores each having an inner surface and a central longitudinal axis, wherein said casting is formed from a castable aluminum-silicon alloy including;
aluminum; and
a plurality of silicon particles present in a range of from about 11 parts by weight to about 12.5 parts by weight based on 100 parts by weight of said castable aluminum-silicon alloy;
wherein said inner surface has a surface variation defined by at least some of said plurality of silicon particles protruding toward each of said respective central longitudinal axes for from about 0.6 microns to about 1.5 microns;
copper present in a range of greater than about 0.5 parts by weight based on 100 parts by weight of said castable aluminum-silicon alloy;
nickel present in a range of greater than about 0.2 parts by weight based on 100 parts by weight of said castable aluminum-silicon alloy;
magnesium present in a range of from about 0.2 parts by weight to about 1.0 part by weight based on 100 parts by weight of said castable aluminum-silicon alloy; and
manganese and iron present in a ratio of greater than about 1.2 parts by weight of said manganese to 1 part by weight of said iron based on 100 parts by weight of said castable aluminum-silicon alloy;
wherein each of said plurality of inner surfaces defines a plurality of pores having an average size of less than about 100 microns and present in a range of less than about 0.1 parts by volume based on 100 parts by volume of said castable aluminum-silicon alloy; and
a plurality of pistons each slideably disposed within a respective one of said plurality of bores to define a plurality of interspaces between each of said plurality of pistons and a respective one of said plurality of inner surfaces, wherein each of said plurality of interspaces has a first thickness of less than or equal to about 25 microns at a temperature of about −40° C.;
wherein each of said plurality of pistons is configured for reversibly translating along a respective one of said plurality of central longitudinal axes, is formed from an aluminum alloy, has a cylindricity of less than about 15 microns, and includes;
a body having a skirt portion, wherein said skirt portion is coated with a first coating; and
at least one ring encircling said body in a plane perpendicular to said respective central longitudinal axis and disposed in contact with said body, wherein said at least one ring has a first end and a second end spaced apart from said first end to define a gap therebetween having a second thickness of from about 4 microns to about 10 microns at a temperature of about −40° C.;
wherein said at least one ring is coated with a diamond-like coating that is substantially free from degradation when disposed in contact with said at least some of said plurality of silicon particles.

19. The linerless engine of claim 18, further including an oil disposed in contact with each of said plurality of bores and said plurality of pistons, wherein said oil is deposited within said plurality of pores at a rate of less than or equal to about 10 grams of said oil per hour as said plurality of pistons each reversibly translates along said respective central longitudinal axis.

20. A linerless engine comprising:
a casting defining a plurality of bores each having an inner surface and a central longitudinal axis, wherein said casting is formed from a castable aluminum-silicon alloy including;
aluminum; and
a plurality of silicon particles present in a range of from about 11 parts by weight to about 12.5 parts by weight based on 100 parts by weight of said castable aluminum-silicon alloy;
wherein each of said plurality of silicon particles has an average particle size of less than about 10 microns and an aspect ratio of less than about 3:1;
wherein said inner surface has a surface variation defined by at least some of said plurality of silicon particles protruding toward each of said respective central longitudinal axes for from about 0.6 microns to about 1.5 microns;
copper present in a range of greater than about 0.5 parts by weight based on 100 parts by weight of said castable aluminum-silicon alloy;
nickel present in a range of greater than about 0.2 parts by weight based on 100 parts by weight of said castable aluminum-silicon alloy;
magnesium present in a range of from about 0.2 parts by weight to about 1.0 part by weight based on 100 parts by weight of said castable aluminum-silicon alloy; and
manganese and iron present in a ratio of greater than about 1.2 parts by weight of said manganese to 1 part by weight of said iron based on 100 parts by weight of said castable aluminum-silicon alloy;
wherein said castable aluminum-silicon alloy is substantially free from primary silicon;
wherein each of said plurality of inner surfaces defines a plurality of pores having an average size of less than about 100 microns and present in a range of less than about 0.1 parts by volume based on 100 parts by volume of said castable aluminum-silicon alloy; and
a plurality of pistons each slideably disposed within a respective one of said plurality of bores to define a plurality of interspaces between each of said plurality of pistons and a respective one of said plurality of inner surfaces, wherein each of said plurality of interspaces has a first thickness of less than or equal to about 25 microns at a temperature of about −40° C.;
wherein each of said plurality of pistons is configured for reversibly translating along a respective one of said plurality of central longitudinal axes, is formed from an aluminum alloy, and includes;
a body having;
a proximal edge;
a distal edge spaced apart from said proximal edge; and
a skirt portion disposed between said distal edge and said proximal edge;
wherein said skirt portion is coated with a first coating at said distal edge that is non-sacrificial and minimizes contact between said aluminum alloy of said piston and said aluminum of said casting as said piston reversibly translates along said respective central longitudinal axis;
wherein said first coating disposed on said skirt portion has a surface roughness of less than about 10 microns; and
at least one ring encircling said body in a plane perpendicular to said respective central longitudinal axis and disposed in contact with said body between said skirt portion and said proximal edge, wherein said at least one ring has a first end and a second end spaced apart from said first end to define a gap therebetween having a second thickness of from about 4 microns to about 10 microns at a temperature of about −40° C.;
wherein said at least one ring is coated with a diamond-like coating that is non-sacrificial and substantially free from degradation when disposed in contact with said at least some of said plurality of silicon particles to thereby minimize contact between said at least one ring and said aluminum of said casting as said piston reversibly translates along said respective central longitudinal axis.
